(19) United States
(12) Patent Application Publication
(10) Pub. No.: US 2009/0189385 A1
(43) Pub. Date: Jul. 30, 2009

(54) METHOD FOR PRODUCING A PERIODICAL PUBLICATION HAVING COMMON AND VARIABLE CONTENT

(76) Inventor: Lloyd Eastwood, Granbury, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/020,858

(22) Filed: Jan. 28, 2008

(51) Int. Cl. B42C 7/00

(52) U.S. Cl. 281/29

(57) ABSTRACT

A method for economically producing a periodical publication includes common content printed using a first plate set in all the issues of an edition for a series and certain variable content unique to a specific issue of the series is printed using a second plate. A fourth color may be printed using the second plate to both complete the four color process for the common content and to print the single color for the variable content.

In another aspect, called two-way sharing, the first plate set may also be used to print the common content for a plurality of series of the same basic periodical edition.

Steps are included for binding special features such as trading cards, fold out posters, etc. into the periodical. The special features may also contain specific content unique to a particular issue.

### BACKGROUND OF THE INVENTION

1. Field of the Invention

The present invention generally relates to printing of periodical publications and more particularly to printing periodicals such as programs for sporting events having common content throughout a season's issues and content that varies from issue to issue.

2. Background of the Invention and Description of the Prior Art

Program booklets produced for athletic events that occur periodically throughout a season, e.g., weekly, become expensive to produce if much of the printed content of such programs is new material for each weekly issue. This problem is especially burdensome for smaller schools where the sales volume is too low to support high volume printing techniques that would make weekly programs economically feasible. The inclusion of new or variable content each week requires a complete new set of plates—and substantial associated costs of printing—for each weekly or periodical issue. In the case of athletic event programs, particularly for smaller schools, the low printing volume often precludes use of variable content because of the cost, and the only option available is to print programs having no variable content. This option has the disadvantage that the booklets must contain more pages to accommodate all of the information, photos, articles, etc. for an entire season's edition, with a corresponding additional cost. Further, much of the content is not as current as it could be, reducing the utility of the program. Thus, there is a need for a method to print relatively small runs of athletic event programs or similar periodicals that have substantial variable content from one week or issue to the next, within a cost structure that is affordable.

### SUMMARY OF THE INVENTION

Accordingly, a method is disclosed for producing a periodical publication that includes fixed and variable content, while using a minimum number of printing plates. The periodical in one example, such as an athletic program for a high school football team, has fixed or common content printed in all the issues of the program of a season (one series) and certain variable content unique to a specific weekly athletic event of the season printed in each weekly issue. The method comprises the steps of: preparing, during a first pre-press operation, a first plate for the common content; preparing, during a second pre-press operation, at least one second plate for the variable content of at least one weekly issue of the periodical; printing during a printing press operation, the common content in a first mode except for designated portions of selected pages; and printing, during a subsequent printing press operation for each issue the variable content in a second mode within the designated portions of the selected pages.

In another aspect, called two-way sharing, the first plate set may also be used to print the common content for a plurality of series of the same basic periodical edition.

In another aspect of the present invention, the first plate set may be configured as three plates for printing the colors cyan, magenta, and yellow, and the second plate set configured as a single plate for printing the black ink for both completing the four color process initiated in the first plate set for the common content and for printing the variable content in the single color black.

In another aspect of the invention, a sheet of trading cards highlighting individual members of a team, printed in full color, with high quality photos, biographical and statistical data, etc., may be bound within the periodical.

In yet another aspect, a full color, fold out poster, containing a full color group photo of a team, may also be bound within the periodical.

### BRIEF DESCRIPTION OF THE DRAWING

FIG. 1 illustrates a perspective view of a periodical publication according to one embodiment of the present invention;

FIG. 2 illustrates a perspective of one aspect of the embodiment of FIG. 1; and

FIG. 3 illustrates a flow chart for one embodiment of the method of producing a periodical for weekly athletic events having common content in all issues and variable content specific to each weekly issue.

### DETAILED DESCRIPTION OF THE INVENTION

In the description that follows, the terms copy, issue, series, and edition have distinct meanings in the context of describing periodical publications. A periodical publication in this description is a printed book or booklet that is printed for distribution at regular intervals. An example is a weekly magazine or athletic program provided by high schools or colleges, or other kinds of entities participating in or hosting sporting or other periodically occurring events. Moreover, the event could be any kind of event that occurs at regular intervals—sporting events, meetings or conventions of organizations, etc.

The periodical published for each occurrence of the event is called an issue of the periodical. Thus, for a given event, a number of copies of that issue are published for distribution at that particular event. A series of the publication refers to a plurality of successive issues of the periodical that are published for events that occur at regular intervals, usually for a particular school or host for the event. If, as in a high school or athletic conference or region, the same basic series of periodical is used for more than one school in the conference, then a plurality of such series of the publication will be called an edition in this description. The type and arrangement of content, the format of the periodical, and its basic appearance of an edition are the same, while the series of the edition that is published for each school will be somewhat different (such as team rosters, photos, coaching staffs, featured groups and persons, etc.). Similarly, each issue of a series will be somewhat different to reflect its publication for a specific event, a game between a host school and a particular opponent, for example. Finally, each school or host will order a certain number of copies of the periodical to distribute at the event covered by the particular issue.

A major cost in printing full color periodicals is the cost of composing and producing the printing plates used in the printing press to print the pages of the periodical. In a color process, one plate is required for each color. In the process to be described, the colors of the inks used by the press are cyan, magenta, yellow, and black. Thus, four plates are required to print a page in full color. Even though computers are used to compose the images for the plates, and machines are used to produce the plates themselves, there is substantial labor involved in these processes, especially in the composition steps. Therefore, reducing the amount of plates required for printing a periodical and the labor charges that are reduced as a consequence provide a proportionate and very significant cost saving benefit to the customer. The savings even extend to setting up the press itself because fewer plates must be installed and registered with each other, also a labor intensive process.

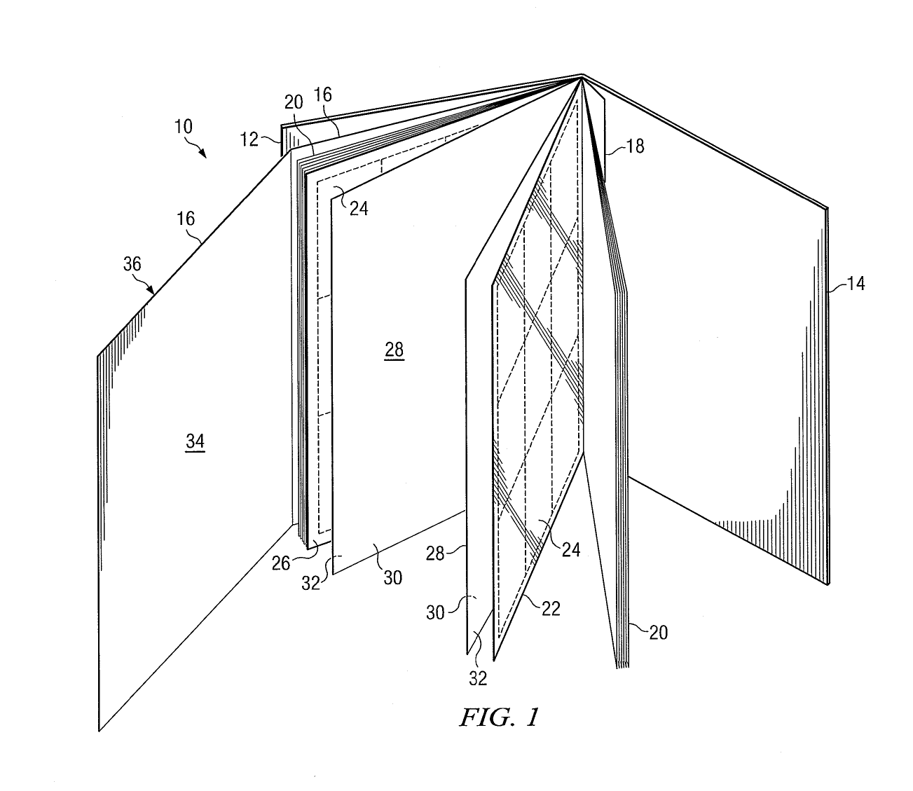

FIG. 1 illustrates a perspective view of a periodical publication or booklet according to one embodiment of the present invention. The publication may be, for example, a program for a series of weekly athletic events having common content in all issues published in a series or for a season and variable content specific to each weekly issue of the series. The present invention may advantageously be adapted to the printing of other types of periodicals without departing from the principles of the invention disclosed herein. The illustration in FIG. 1 depicts a booklet having seven representative sheets—i.e., fourteen pages—assembled between the front and back halves of a cover sheet. Each sheet of pages in the drawing may represent a plurality of pages of an actual printed periodical. For example, in some school districts or athletic conferences, a typical program for an athletic event may include 80 pages, not including the cover and special inserts such as fold out posters and trading card pages. The number of sheets shown in the drawing is reduced for clarity to represent the several types of pages that may be bound into the periodical according to the present invention.

As mentioned, a typical athletic program 10 may have 80 pages, wherein each page may be approximately 8½″×11″. The 80 pages maybe provided for example in five signatures of 16 pages, eight to a side of one standard printing sheet measuring approximately 25″×38″. The covers for the publication and inserts such as fold out (or, alternatively, gatefold) posters and the like for the program may be separately printed on the same size and weight sheet, typically four to a sheet. Other inserted features that may be imposed into the publication include trading cards, printed nine to a page, in a 3×3 format on heavy tag stock such as “16 Point” weight paper or its equivalent. Generally, the trading card “sheets” may be approximately 11″17″ overall to provide two pages of trading cards, having, for example, nine trading cards on each page or half-sheet. The trading card sheets are typically printed on both sides of the sheet, as will be described. The individual trading card pages may be approximately 7½″×10½″ measured at the borders of the trading cards, leaving a small margin around the outer edge of an 8½″×11″ sheet. The pages of the trading cards may preferably be perforated along the trading card borders for ease of removal. With nine cards per page, individual cards maybe approximately 2½″ wide and 3½″ high. As will also be described, the fold out or gatefold posters and/or the trading card sheets may be imposed between or next to selected signatures into the periodical prior to the binding operation. The typical periodical of the present invention may be printed on a four-color, sheet-fed, offset press. Thus, the composition of the athletic periodical in this example is organized to exploit the efficiencies of the sheet-fed, offset press. A principle object of the invention is to minimize the number of separate printing plates that must be produced in printing each issue and the entire edition of the periodical. Producing the plates for printing is the largest single portion of the cost of printing such publications.

In an athletic program, for example, certain kinds of copy are fixed, that is, the same copy is used in all weekly issues of a series or season edition. Such copy that is “fixed” is common to all issues, including e.g., most advertising, news of general interest, home team rosters, photos, articles about the home team school, etc., which may be printed in every issue. Other kinds of copy, such as content that is for the exclusive use or interest of each school, i.e., school-specific content, varies from issue to issue of the series, and so is called “variable copy.” The variable copy may also include advertisements, along with, e.g., visiting team rosters, photos, and articles. The variable copy may also include such subject matter as individual profiles of team members, coaches, school officials, feature articles, etc., that are directly related to event corresponding to the particular issue of the serial or periodical publication. Especially important in periodicals of this type is the advertising sold for each issue. Some advertisers support the entire season's events or the entire series of periodicals while others prefer to support specific, selected issues to run their advertisements. As will be explained, the content common to all issues may be printed using one first set of plates and the content that varies with each issue may be printed using another second set of plates. The first set of plates will be used to print the pages for all periodic issues of the periodical, producing “shells” to be stored and later printed in individual print runs for each issue. This first set of plates will print the common content and leave blank the areas of each affected page that will be printed with the variable content using the second set of plates when each particular issue is printed.

Continuing with FIG. 1, the periodical 10 includes a front cover 12 and a back cover 14, which may be provided by a single sheet (11×17″ this example) and printed in full color on both sides. Assembled into the periodical 10 of FIG. 1 is a fold out or poster page 16 (approximately 11″×17¼″), which may be bound into the periodical along one edge 18 of the foldout sheet, leaving a small margin of paper along the one edge 18 to secure the foldout page in the binding. The fold out or poster page 16 may be perforated along a line (not shown) that is parallel and adjacent to the binding of the periodical 10. The perforation of the fold out page 16 is provided to permit its easy tear-out removal. The foldout page 16, which is preferably be used to provide a full color poster photograph or other artwork, is shown having a first (front) side 34 and a second (back) side 36. Either the front side 34 or the back side 36 may be printed as a foldout poster having a large two-page image of a team or an individual. As shown, the foldout page 16 has been folded out to reveal its configuration and to enable viewing the art more readily.

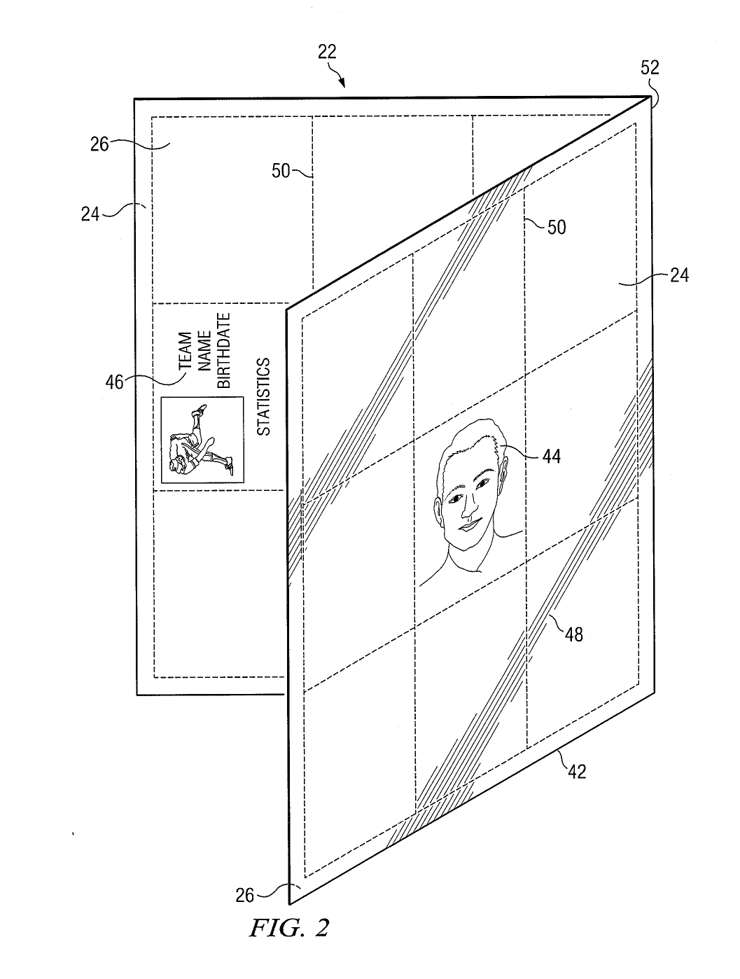

Next shown in FIG. 1 is a plurality of inside pages 20 represented by a single sheet. In actual practice the number of inside pages 20 may vary considerably, e.g., from one sheet to several signatures. A trading card sheet 22 is also bound into the periodical 10. The trading card sheet 22 may be a single sheet of heavy card stock approximately 11″×17″. The trading card sheet 22 has a first side 24 and a second side 26. The first side 24 in this example is shown as a front (“recto”) side, which may contain full color portrait photo images of individual athletes, for example. The second side 26 in this example is shown as a back (“verso”) side, which may contain full color or single color material such as statistics, biographical information, or other information or photos. The trading card sheet will be described in more detail in conjunction with FIG. 2.

Further in the periodical 10 shown in FIG. 1, a centerfold page 28, also approximately 11″×17″, is illustrated having a front side 30 and a back side 32. As is well known, a centerfold page is generally imposed and bound into the center of the periodical 10. Any type of image may be printed on the centerfold 28. For example, a two-page photo of an entire team of athletes, or cheerleaders, or coaches maybe shown in a group photo on the facing front side 30 of the centerfold 28. The back sides 32 of the centerfold may be printed as any other “inside ” page 20.

FIG. 2 illustrates a perspective of a trading card sheet 22 of the embodiment of FIG. 1. The trading card sheet 22 is defined with a first side 24 and a second side 26, and is shown folded along a binding edge 52. The trading card sheet 22 may be printed on an 11″×17″ piece of heavy card stock 42, such as “16 Point” weight paper or its equivalent. The trading card sheets are typically printed on both halves of the sheet in a 3×3 matrix, providing nine cards per half sheet. The individual trading card pages may be approximately 7½″×10½″ measured at the borders of the trading cards, leaving a small margin around the outer edge of the sheet. The pages of the trading cards may preferably be perforated along the trading card borders for ease of removal. With nine cards per page, individual cards may be approximately 2½″ wide and 3½″ high. The first or front side 24 in this example is shown as a front (“recto”) side, which may contain full color portrait photo images 44 of individual athletes, for example. The second or back side 26 in this example is shown as a back (“verso”) side, which may contain secondary material 46 such as statistics, biographical information, or other information or photos. The secondary material 46 may be printed in full color or single color as preferred. The first/front/recto side 24 may be protected from the effects of light or from soiling by laminating a very thin sheet of plastic film material 48 to the surface of the first/front/recto side 24. Such film acts as a filter for ultraviolet energy in the light reaching the trading card(s). In some applications, the second/back/verso side 26 may be laminated with the plastic film material 48. Following lamination of the plastic film material 48, the trading card pages 22 may be perforated along the dashed lines to permit easy separation of the individual trading cards from the trading card sheet 22.

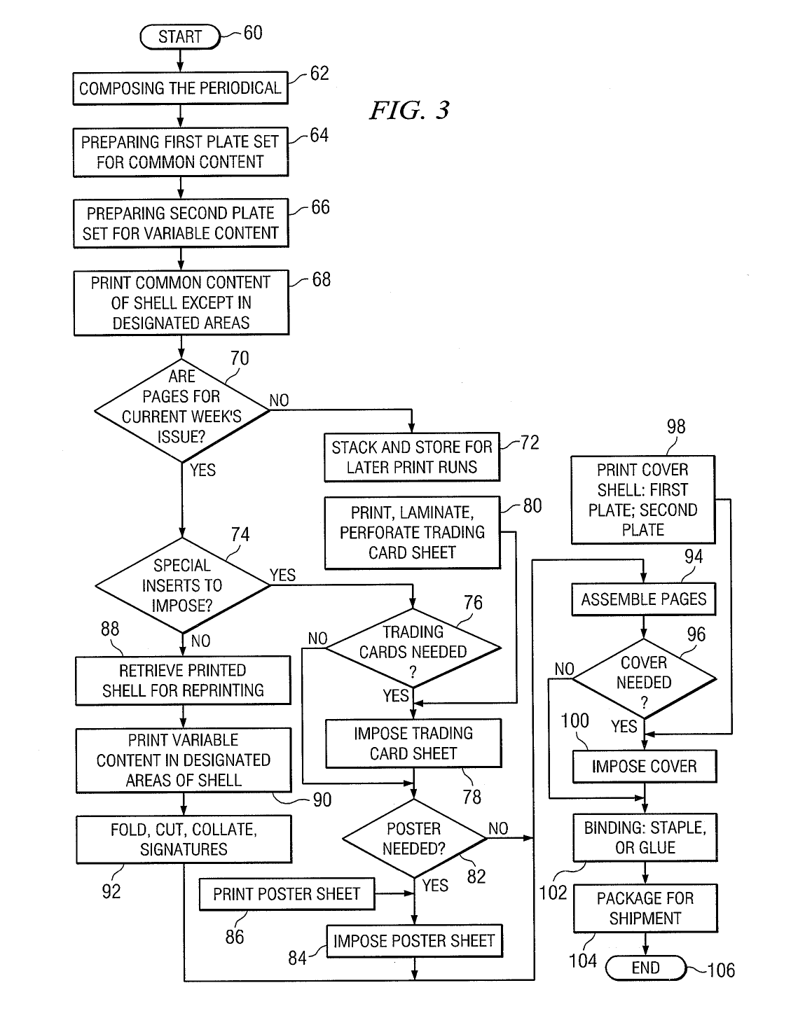

Referring to FIG. 3, there is illustrated a flow chart of one embodiment of the method of producing a periodical for weekly athletic events having common content in all issues and variable content specific to each weekly issue. In the description that follows, a “shell” in the context of the present invention is generally a printing sheet that has been passed through the printing steps once to print the common content and will be reprinted in a second pass as necessary to imprint the variable text. The term ‘shell’ may also be used to refer collectively to the plurality of sheets that have been imprinted from the first plate for a given periodical. The flow in FIG. 3 begins at a start block 60 and then advances to the step 62 for composing the various pages—the pre-press “layout”—of the periodical. In the example to be described herein, a typical athletic program having 80 pages, wherein each page may be approximately 8½″×11″ is described. In FIG. 3, the composing step 62 may be performed on a computer system and reduced to one or more electronic files. The files may be transmitted electronically or via a memory device such as a recording in a variety of media such as a compact disc (CD) to a pre-press operation. In the pre-press operations, typically performed by one of several types of well-known photographic processes that do not require further explanation here, first and second plates are produced. The plates will preferably be adapted for use on the rotary drum of a sheet-fed offset press as will be appreciated by persons of ordinary skill in the art.

The first plate may be prepared in step 64 for printing the common content, that is, with content that remains constant through several issues of the periodical. In a typical periodical such as the athletic program described herein, most of the pages contain substantial common content. Thus, most of the printed pages may be printed in color from one set (the first set) of printing plates, thereby realizing the cost saving afforded by a single print set up and run for an entire edition or season. It will be understood by persons skilled in the art that one plate will be used to print each side of a standard sheet of paper. The standard sheet size, typically approximately 25″×38″ can provide in one “signature” eight individual two-sided pages, each approximately 8½″×11″ for a total of sixteen pages. As mentioned, the first plate set may be run in a first, full color mode. Then the second plate set (i.e., usually a single plate) may be run in a second, single color mode at much lower cost because only one plate is necessary to complete the printing of the pages. Often, the single color may be black. Designated areas of the first plate that are reserved for the variable content are left blank or may be printed in a single background color during the first printing run.

The periodical may typically be designed to print as much of its content as possible as common content that is the same for every issue of the series. Thus, the maximum economy of scale (due to the quantity needed for the entire series or season) is realized by printing the common content all in one operation. This single run will also typically be used to print most or all of the four color pages, again in an effort to benefit from printing the full color pages in a single operation. Thus, the first plates, which are actually a set of four plates (or, in some cases, just three plates, as will be described) installed in the four color offset press, can be set up, registered, and used to print all of the shells required for a full season's edition in a single printing. Then the variable content is printed using a second plate in a second run of the shell through the offset press. Typically, each page of the periodical that features school-specific content may also have a designated space for advertising only on each page. For example, an inch high strip across the bottom of the pages, except, e.g. for the cover, may be used for advertising copy printed during the second printing run.

The second plate may be prepared in step 66 for printing the content that varies from issue to issue in the designated areas. A second plate, usually a single color, often black, is produced for each standard sheet that will include the variable content for the particular issue being printed. In fact, for some editions, the same black color plate, run during the second printing run, also supplies the black ink needed to complete the full four color (CMY and black) copy when only three plates—for cyan, magenta, and yellow—were used to print the common content during the first printing run. This method enables one less plate to be used for printing the shell in the first run, a substantial cost saving. This saving applies to the entire edition as well as each issue of the periodical because the copy from the second plates will be imprinted into blank areas of the shell produced from the first plate after the common content is printed in step 68. It is possible, indeed desirable from a cost standpoint, to include the variable content in fewer than all of the shells used in a given edition of the periodical. This also reduces the number of plates that must be produced. Continuing with step 70, a determination is made whether the sheet just printed is for the current issue; if NO, the flow proceeds to step 72 where the sheet will be stacked and stored for later print runs; if YES, the flow advances to step 74.

The output of the decision step 70, “Are pages for the current week's issue?” is applied to another decision step to determine, in step 74, whether any special pages or inserts such as trading cards or fold out pages or gatefold posters are to be imposed into the periodical. If NO, the process proceeds to step 88 to retrieve the printed shell from storage for reprinting using the second plates, followed by a step 90 to print the variable content in the designated areas of the shell, and followed further by step 92 to fold, cut, and collate the printed signatures. If, however, the answer to the decision step 70 is YES, the flow advances to step 76, a decision step that asks whether a trading card insert is needed in the current issue? If the response to the query in step 76 is YES, the flow advances to step 78 to impose a trading card sheet printed previously in a step 80 to be described below. If NO, the process proceeds to a step 82, a decision step that asks whether a poster insert is needed in the current issue. Again, is YES, the flow advances to step 84 to impose the poster sheet printed previously in a step 86 to be described below. If NO, the process proceeds to a step 94 to assemble the page(s) to be imposed with the pages that have been folded, cut and collated in step 92.

Continuing with FIG. 3, the flow advances to step 96, a decision step that determines whether a cover for the periodical is needed. If YES, the flow advances to step 100 to impose a cover for the particular issue that was previously printed in a step 98. After step 100, the periodical advances to step 102 to be bound by an appropriate well-known process such as stapling or gluing and the like. If, In step 96 it was determined that a cover is not needed, the process proceeds directly to step 102 to be bound as described. Following binding of the periodical, the periodicals are packaged for shipment, including any necessary inspection steps. The process ends at step 106.

During the foregoing process, two kinds of special inserts, respectively trading cards and posters, were imposed into the periodical at steps 78 and 84. These inserts are a particular feature not heretofore known to be available in relatively low volume athletic programs or other similar weekly periodicals. In step 80, the trading cards may, for example, be printed on heavy card sheets, approximately 11″×17″ for use in a publication having approximately 8½″×11″ pages, to provide two pages of rectangular trading cards to be bound into the periodical. Each rectangular trading card may contain a pictorial image and/or textual information on either side of the trading card. The card images may be printed in a 3×3 array, in three columns of three cards per column on each half of the 11″×17″ card sheet. With this array of cards imposed in a periodical approximately 8½″×11″, each card may be approximately 2½″ wide and 3½″ high. Thus, the array for each page in this example is approximately 7½″ wide and 10½″ high. A four color photo image of an athlete, for example, may be printed on the first/front/recto side 24 of each card, and a single color data panel about the individual athlete may be printed on the second/back/verso side 26 of each trading card of the card sheet 22. Following printing of the trading card sheet, it may preferably be laminated on the first/front/recto side 24 with a very thin film of clear plastic, ultra-violet filtering material to protect the photographic images from fading due to exposure to sunlight or from damage due to handling and the like. The card sheet may then be perforated by well known processes along the borders between the trading card images to enable easy separation for trading or storage as decks of cards, mounting in scrapbooks, etc.

In step 86, the fold-out poster may, for example, be printed on an appropriate sheet size, such as 11″×17″ for a typical fold out page in a periodical having a page size of approximately 8½″×11″. The poster may preferably be a four color image, and may be imposed into the periodical at a selected location, usually between signatures of the periodical.

Much of the foregoing description has been from the perspective of printing periodicals for a single customer through a series of weekly events such as one school's series of weekly athletic programs. It has been pointed out herein that by dividing the copy into common and variable groups, a savings in the number of printing plates needed for printing successive issues of the periodical is realized for that customer, i.e., that one school. This method thus relies on a one-way or one-dimensional sharing of the plate usage for the common content to reduce the number of printing plates that must be produced. The term one-way or one-dimensional refers to a single series of a periodical publication that shares common content in all periodic issues of the series.

There is yet an additional way to share the plate usage, realizing further cost savings for printing a weekly issue of the periodical. Called two-way or two-dimensional sharing, the method is to use the same plates for printing the common content in similar periodicals—the athletic programs, in this example—for more than one customer or school. In two-way or two-dimensional sharing, the same set of plates (first plate set) is also used for printing the common content in a plurality of series of the same basic periodical edition. This works well for competitive events between schools in the same athletic conference or league, for example. With two-way sharing, the utility of the same set of plates for the common copy is multiplied by the number of customers or schools that purchase the same basic periodical for their weekly athletic programs. Since the customers or schools in such an arrangement are usually in the same region, advertising content and other common content can be unchanged throughout the region for a plurality of schools as well as throughout the season for a plurality of issues. The cost per copy is proportionately reduced, enabling the smaller customers or schools to provide programs that would otherwise be too expensive.

By way of example, consider an edition of a periodical for one customer (a first series) to be printed for five weekly issues. The cost of the common content for the first series is spread among all of the copies of the five weekly issues. If a weekly run for this customer is 2,000 copies, then the cost of producing the plates for the common content is 5×2,000=10,000 copies with one-dimensional sharing. If there are six customers sharing the same basic periodical edition, such as six schools in the same athletic conference or region, six series of the basic periodical can be printed with the same first plate set and the total cost of that first plate set for the common content for all the series is divided by six, that is, 6×10,000=60,000 copies with two-dimensional sharing. Thus the total cost of producing the four plates of the first plate set needed to print this common copy is divided by 60,000 instead of by only 10,000. This is a very significant cost reduction, particularly in the present example where the common content may involve as much or more than thirty percent of the pages of the periodical.

Returning to FIG. 3, the process steps are the same for printing a periodical issue of one series of the periodical (i.e., for one customer, such as one school, for its season of athletic events) and for printing a plurality of different series of the periodical, each series being for a different customer for its season of athletic events. Thus, the step 66, “preparing a second plate set for the variable content” of the series for a given customer will be a different “second plate set” for each customer. Further, each customer needing a periodical publication for a series of events will have its own “second plate set” for its variable content and share the common content that is in the “first plate set” of step 64. Moreover, when the first plate set is run to print the common content that is printed in the “shells” the run for producing the shells for all issues of all series of the periodical is performed at the same time and stored for use as in step 72. Then, when each issue of a series for a customer is set up for printing using its second plate set, as in step 90 of FIG. 3, enough shells for running that issue are withdrawn from the stored shells (see step 72) and printed. Therefore, while each issue of the periodical is customized as to the variable content, which requires a separate set of plates, each issue also shares common content with all of the issues of all of the series. The plate set cost for the common content is shared with all customers, which multiplies the cost savings per page to each customer. Since most of the common content is advertising, the costs per page of providing the advertising messages and information is very low, benefitting both the advertisers and the customers (the schools). The advertisers receive maximum exposure and the schools can provide high quality, full color periodicals—e.g., athletic programs—at an affordable cost using the method of the present invention described herein.

To summarize the foregoing method when it is exploited to print more than one series of the periodical, the method involves a repetition of several steps, in particular, steps 66 and 90, for each issue of the additional series. For example, these steps may be expressed as:

preparing, during a subsequent pre-press operation (a repetition of step 66), a corresponding plate set for printing the variable content of at least the one shell for an additional series of weekly issues of the periodical; and

printing, during a subsequent printing operation (a repetition of step 90) using the corresponding plate set for each weekly issue of the additional series of weekly issues, the variable content within the designated portion of the selected pages of the at least one shell.

While the invention has been shown in only one of its forms, it is not thus limited but is susceptible to various changes and modifications without departing from the spirit thereof.

What is claimed is:

1. A method of producing a periodical publication having substantial common content and selected variable content printed in respective weekly issues, comprising the steps of:
preparing, during a first pre-press operation, a first plate set for printing the common content of at least one shell in full color;
preparing, during a second pre-press operation, a second plate set for printing the variable content of the at least one shell for each weekly issue of the periodical;
printing, during a printing press operation using the first plate set, the common content in the at least one shell except for designated portions of selected pages of the at least one shell; and
printing, during a first subsequent printing press operation using the second plate set for each weekly issue, the variable content within the designated portions of the selected pages of the at least one shell.

2. The method of claim 1, further comprising the step of:
binding pages of all common and variable content to form each copy of the periodical.

3. The method of claim 1, further including the steps of:
preparing the first and second plates in a computer operated photographic pre-press operation; and
installing the first and second plates on a respective rotary drum of a sheet-fed offset printing press.

4. The method of claim 1, further comprising the step of:
printing the common content in a full color first mode.

5. The method of claim 4, further comprising the step of:
printing the full color first mode in the secondary colors of cyan, magenta, yellow, and black.

6. The method of claim 1, further comprising the step of:
printing the variable content in a single color second mode.

7. The method of claim 2, further comprising the step of:
binding at least one additional sheet in the periodical.

8. The method of claim 7, wherein the step of binding comprises the step of:
binding at least one sheet of trading cards in a designated issue of all of said issues of the periodical.

9. The method of claim 8, wherein the binding step comprises the steps of:
printing a plurality of rectangular trading card images on both sides of a heavy card sheet, each card having a boundary coinciding with the edges of the rectangular trading card, wherein each sheet includes a margin along a left side edge of the sheet as viewed from a front side of the sheet;
laminating the printed sheets on at least the front side with a thin film of ultra-violet-filtering material;
perforating the printed and laminated sheets along each boundary to facilitate separation of individual trading cards; and
imposing the printed, laminated, and perforated sheet of trading cards into a predetermined first position between adjacent signatures of the issue of the periodical associated with the images.

10. The method of claim 2, wherein the binding step comprises the steps of:
binding at least one fold-out poster sheet in a designated issue of all of said issues of the periodical.

11. The method of claim 10, wherein the binding step comprises the steps of:
printing the fold-out poster sheet in a fill color first mode; and
imposing the fold-out poster sheet into a predetermined second position between adjacent signatures of the issue of the periodical associated with subject matter of the poster sheet.

12. The method of claim 8, further comprising the steps of:
arranging nine trading cards in a rectangular 3×3 arrangement per sheet.

13. The method of claim 8, further comprising the steps of:
printing a portrait image of a team member on the front side of the trading card; and
printing personal data of the team member on the back side of the trading card.

14. The method of claim 1, wherein each step of printing comprises the step of:
using a sheet-fed, offset printing process.

15. The method of claim 2, wherein the step of binding comprises the steps of:
binding at least one sheet of trading cards in a designated issue of all of said issues of the periodical; and
binding at least one fold-out poster sheet in the designated issue of all of said issues of the periodical.

16. The method of claim 1, further comprising the steps of:
preparing, during a third pre-press operation, a third plate set for printing the variable content of at least the one shell for a second series of weekly issues of the periodical; and
printing, during a second subsequent printing operation using the third plate set for each weekly issue of the second series of weekly issues, the variable content within the designated portion of the selected pages of the at least one shell.

17. The method of claim 1, further comprising the steps of:
preparing, during a subsequent pre-press operation, a corresponding plate set for printing the variable content of at least the one shell for an additional series of weekly issues of the periodical; and
printing, during a subsequent printing operation using the corresponding plate set for each weekly issue of the additional series of weekly issues, the variable content within the designated portion of the selected pages of the at least one shell.

18. A method of producing an edition of a periodical publication having substantial common content among each issue and selected variable content printed in respective weekly issues of a plurality of series, comprising the steps of:
preparing, during a first pre-press operation, a first plate set for printing the common content of at least one shell in at least three colors for printing the common content in all weekly issues of each of the plurality of series;
preparing, during a second pre-press operation, a second plate set for printing the variable content and the fourth color of the at least one shell for each weekly issue of one of the plurality of series of the periodical;
printing, during a printing press operation using the first plate set, the common content in the at least one shell except for designated portions of selected pages of the at least one shell; and
printing, during a subsequent printing press operation using the second plate set for each weekly issue of the one of a plurality of series of the periodical, the variable content within the designated portions of the selected pages of the at least one shell.

19. The method of claim 18, further comprising the step of:
binding pages of all common and variable content to form each copy of the periodical.

20. The method of claim 18, further including the steps of:
preparing the first and second plates in a computer operated photographic pre-press operation; and
installing the first and second plates on a respective rotary drum of a sheet-fed offset printing press.

21. The method of claim 18, further comprising the step of:
printing the common content in a full color first mode.

22. The method of claim 21, further comprising the step of:
printing the full color first mode in the secondary colors of cyan, magenta, yellow, and black.

23. The method of claim 18, further comprising the step of:
printing the variable content in a single color second mode.

24. The method of claim 18, wherein each step of printing comprises the step of:
using a sheet-fed, offset printing process.

25. A method of producing a periodical publication having substantial common content and selected variable content printed in respective weekly editions, comprising the steps of:
preparing, during a first pre-press operation, a first plate set for printing the common content of at least one shell in at least three colors;
preparing, during a second pre-press operation, a second plate set for printing the variable content and the fourth color of the at least one shell for a weekly issue of the periodical;
printing, during a printing press operation using the first plate set, the common content in the at least one shell except for designated portions of selected pages of the at least one shell; and
printing, during a subsequent printing press operation using the second plate set for each weekly issue, the variable content within the designated portions of the selected pages of the at least one shell.

26. The method of claim 25, further comprising the steps of:
preparing the first plate set to print the colors cyan, magenta, and yellow; and
preparing the second plate set to print the color black.
